(19) United States
(12) Patent Application Publication
(10) Pub. No.: US 2026/0044506 A1
(43) Pub. Date: Feb. 12, 2026

(54) SMALLER TASK SIZES FOR THE PROJECTION PIPELINE

(71) Applicant: SAP SE, Walldorf (DE)

(72) Inventors: Christina Teflioudi, Heidelberg (DE); Paul Willems, Heidelberg (DE); Marius Eich, Neustadt (DE)

(21) Appl. No.: 18/800,494

(22) Filed: Aug. 12, 2024

(51) Int. Cl. G06F 16/2453

(52) U.S. Cl. CPC G06F 16/24542

(57) ABSTRACT

A database execution engine initiates generation of a query plan on a projection pipeline for a received query. In response to initiating generation of the query plan, the database execution engine determines a first estimate of total work that will be parallelized by a scheduling operator for the query plan. Also, the database execution engine determines a second estimate of a final result size at the projection pipeline. Next, the database execution engine calculates a target number of rows based on a pause threshold and one or more configuration parameters. Then, the database execution engine calculates a task size upper bound by multiplying the target number of rows by the first estimate divided by the second estimate. During execution of the query plan, the database execution engine applies the task size upper bound to task sizes for result streaming threads scheduled by the scheduling operator on the projection pipeline.

### TECHNICAL FIELD

The present disclosure generally relates to database management and, more specifically, to query execution on database tables.

### BACKGROUND

Database management systems have become an integral part of many computer systems. For example, some systems handle hundreds if not thousands of transactions per second. On the other hand, some systems perform very complex multidimensional analysis on data. In both cases, the underlying database may need to handle responses to queries very quickly in order to satisfy systems requirements with respect to transaction time. A database query is a mechanism for retrieving data from one or more database tables. Queries may be generated in accordance with a corresponding query language. For example, structured query language (SQL) is a declarative querying language that is used to retrieve data from a relational database. Given the complexity of queries and/or the volume of queries, the underlying databases face challenges when attempting to optimize performance.

### SUMMARY

In some implementations, a database execution engine initiates generation of a query plan on a projection pipeline for a received query. In response to initiating generation of the query plan, the database execution engine determines a first estimate of total work that will be parallelized by a scheduling operator for the query plan. Also, the database execution engine determines a second estimate of a final result size at the projection pipeline. Next, the database execution engine calculates a target number of rows based on a pause threshold and one or more configuration parameters. Then, the database execution engine calculates a task size upper bound by multiplying the target number of rows by the first estimate divided by the second estimate. During execution of the query plan, the database execution engine applies the task size upper bound to task sizes for result streaming threads scheduled by the scheduling operator on the projection pipeline.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a database system, in accordance with some example implementations of the current subject matter;

FIG. 2 illustrates a block diagram of a database execution engine, in accordance with some example implementations of the current subject matter;

FIG. 3 illustrates a block diagram of a result streaming environment, in accordance with some example implementations of the current subject matter;

FIG. 4 illustrates a process for enforcing an upper bound for task sizes in result streaming query processing, in accordance with some example implementations of the current subject matter;

FIG. 5A depicts an example of a system, in accordance with some example implementations of the current subject matter;

FIG. 5B depicts another example of a system, in accordance with some example implementations of the current subject matter; and

FIG. 6 illustrates a diagram of an example projection pipeline, in accordance with some example implementations of the current subject matter.

### DETAILED DESCRIPTION

In a query execution engine that uses pipelining, the data is broken into small parts, each of which is processed by a series of operators. It is noted that this does not refer to high-level relational algebra operators, but to low-level operators (i.e., code units that perform a specific operation during execution). Such operators are connected with each other to form a directed acyclic graph. Operators with no outgoing links split the graph into multiple pipelines. In other words, a pipeline ends on an operator with no outgoing links and starts with an operator after the previous pipeline ended. The execution takes place in a recurrent fashion (i.e., operator n takes a chunk of data as input, performs some operation on it and pushes the corresponding output to the operator n+1). After the last operator in the pipeline is done, control is returned to the operator before it (i.e., when operator n+1 is finished, control returns to operator n). Operator n, depending on its nature, may or may not continue processing, such as by producing another piece of data and pushing it down the pipeline of operators, or by performing some clean up task and by freeing resources.

Pipelines or parts of pipelines are parallelized by the scheduling framework of the query execution engine. In more detail, relations that might require parallelization (e.g., TableScan) include scheduling operators (e.g., TableScanScheduleOp). Such operators decide if the part of the pipeline after them (e.g., the table scan) should be parallelized and if yes, they break the total input of the relation into smaller pieces which are referred to as tasks. The operators then communicate these tasks to the scheduling framework. The scheduling framework is responsible for creating worker threads that repeatedly pick up tasks and process them. For example, a TableScheduleOp might break the total work of 100 million rows into tasks of 1 million rows each. The scheduling framework might then create 10 workers which have to process all 100 tasks.

In a data request query from a client to a server, the client may send an “open” request to initiate the query, followed by one or more “fetch” requests to receive results until all results are received. At that point, the client may close the query. Query execution for this process is typically done in the same thread which receives the open and fetch requests. This may result in the server computing a full query result in response to the initial open request. This is a time intensive process in which server resources are expended prior to results being required, thus opening up a possibility of wasting resources. For example, in some instances, the client may choose not to send one or more fetch requests to obtain all of the results. But as the server has computed the full query result, the server has clearly wasted processing resources by computing the full query result at the onset of the open request. Moreover, from the client's perspective, the computation of the full query result leads to extra time during which the client is waiting for the first fetch result.

To deal with the aforementioned scenario, query execution may be divided into multiple phases/calls during which a client requests the data produced by the query in small parts. With result streaming, processing all of the data is avoided. Instead, enough data is processed to satisfy the next customer request call. If more requests are issued from the customer side, more data is processed, but if the customer is only interested in the first few results, processing can stop at that point.

In an example, an execution framework employing result streaming makes use of two thresholds: one for pausing and one for resuming execution. There are buffers where the produced results are stored and from where the results are fetched according to the needs of the customer. Once enough results (e.g., greater than a pausing threshold) are buffered in the internal buffers, the execution can pause, and once the amount of results in the buffers fall below the resuming threshold, the execution resumes. It is noted that when execution is paused, it is not paused instantly. Instead signals are sent to the workers that are active at that time that they should not pick another task to process, but they should sleep on some semaphore until it is time to resume execution again. However, if the workers have already have been working on a task at the time the pause signal arrives, they still have to finish processing the current task (i.e., they do not pause mid-task). This practically means that the task size can affect how well result streaming is working. Very large tasks would be counterproductive for result streaming, but very small tasks could introduce overheads in the task scheduling framework.

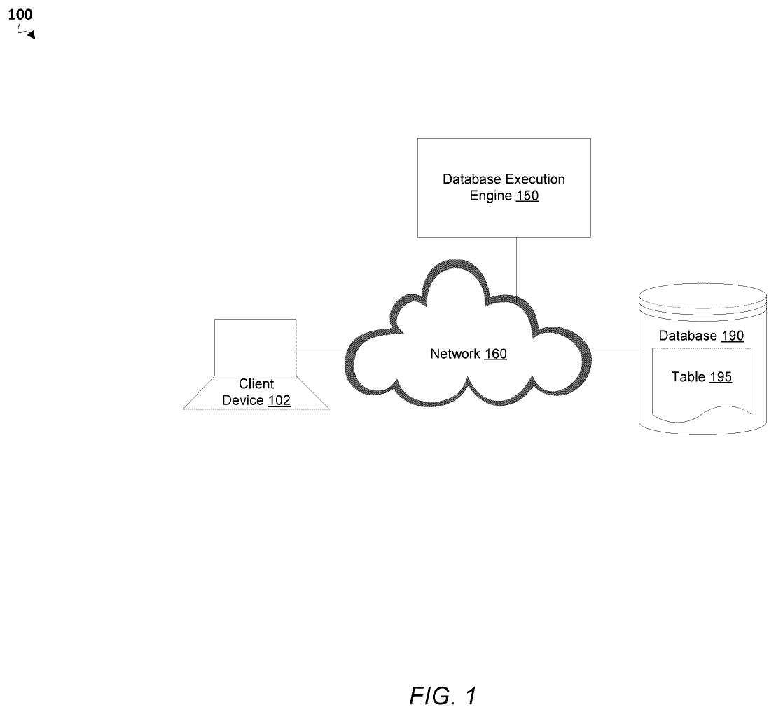

FIG. 1 depicts a system diagram illustrating an example of a database system 100, in accordance with some example embodiments. Referring to FIG. 1, the database system 100 may include one or more client devices 102, a database execution engine 150, and one or more databases 190. As shown in FIG. 1, the one or more client devices 102, the database execution engine 150, and the one or more databases 190 may be communicatively coupled via a network 160. The one or more databases 190 may include a variety of relational databases including, for example, an in-memory database, a column-based database, a row-based database, and/or the like. The database execution engine 150 may store a database table 195 at the one or more databases 190, with the database table 195 representative of any number and type of tables.

In some example embodiments, the one or more databases 190 may include a relational database. However, it should be appreciated that the one or more databases 190 may include any type of database including, for example, an in-memory database, a hierarchical database, an object database, an object-relational database, and/or the like. For example, instead of and/or in addition to including a relational database, the one or more databases 190 may include a graph database, a column store, a key-value store, a document store, and/or the like.

The one or more client devices 102 may include processor-based devices including, for example, a mobile device, a wearable apparatus, a personal computer, a workstation, an Internet-of-Things (IOT) appliance, and/or the like. The network 160 may be a wired network and/or wireless network including, for example, a public land mobile network (PLMN), a local area network (LAN), a virtual local area network (VLAN), a wide area network (WAN), the Internet, and/or the like.

To illustrate by way of an example, a given client device 102 may send a query via the database execution engine 150 to the database layer including the one or more databases 190, which may represent a persistence and/or storage layer where database tables may be stored and/or queried. Furthermore, the database execution engine 150 may provide the ability to access table storage via an abstract interface to a table adapter, which may reduce dependencies on specific types of storage and persistence layers, which may in turn enable use with different types of storage and persistence layers.

The database execution engine 150 may be configured to handle different types of databases and the corresponding persistent layers and/or tables therein. For example, the one or more databases 190 may include at least one row-oriented database, in which case an insert is performed by adding a row with a corresponding row identifier. Alternatively and/or additionally, the one or more databases 190 may include one or more column store databases, which may use dictionaries and compressive techniques when inserting data into a table. Where the database layer includes multiple different types of databases, the database execution engine 150 may perform execution related to handling the differences between different types of databases such as row-oriented databases and column store databases. This may enable a reduction in processing at the database layer, for example, at each of the one or more databases 190. Moreover, the database execution engine 150 may perform other operations including rule-based operations, such as joins and projections, as well as filtering, group by, multidimensional analysis, and/or the like to reduce the processing burden on the database layer. In this way, the database execution engine 150 may execute these and other complex operations, while the one or more databases 190 can perform simpler operations to reduce the processing burden at the one or more databases 190.

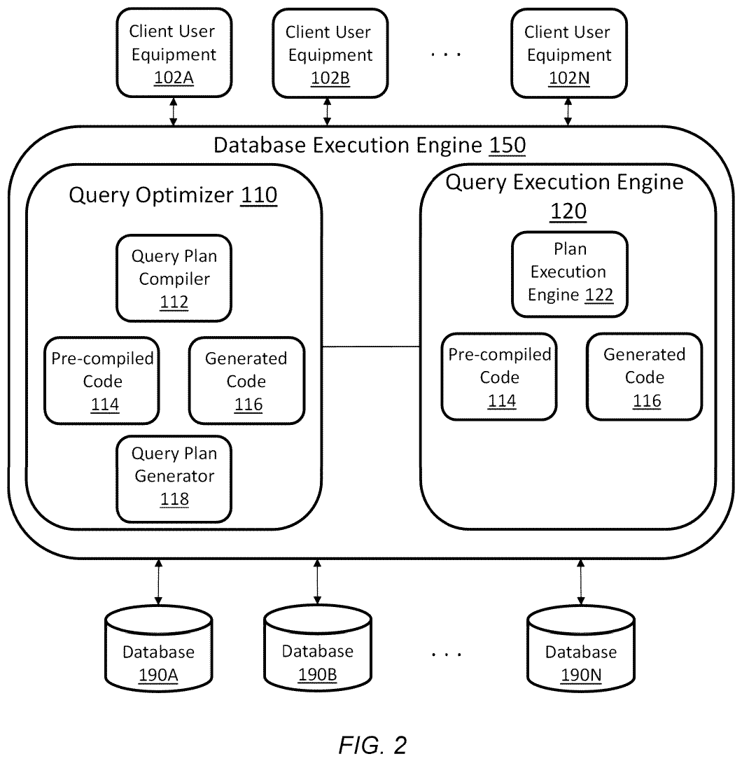

FIG. 2 depicts a block diagram illustrating an example of the database execution engine 150, in accordance with some example embodiments. As shown in FIG. 2, the one or more databases 190 may include a first database 190A, a second database 190B, a third database 190N, and so on. The one or more databases 190 can represent the database layer of a database management system (DBMS) where data may be persisted and/or stored in a structured way, and where the data may be queried or operated on using operations such as SQL commands or other types of commands/instructions to provide reads, writes, and/or perform other operations. To illustrate by way of an example, one or more client devices, which may include the client user equipment 102A-N, may send queries via the database execution engine 150 to the database layer including the one or more databases 190, which may represent a persistence and/or storage layer where database tables may be stored and/or queried. The queries may be sent via a connection, such as a wired connection and/or wireless connection (e.g., the Internet, cellular links, WiFi links, and/or the like) provided, for example, by the network 160.

In an example, the database execution engine 150 may include a query optimizer 110, such as a SQL optimizer and/or another type of optimizer, to receive at least one query from the one or more client devices 102 and generate a corresponding query plan (which may be optimized) for execution by a query execution engine 120. The query optimizer 110 may receive a request, such as a query, and then form or propose an optimized query plan. The query plan (which may be optimized) may be represented as a so-called “query algebra” or “relational algebra.” The query plan may propose an optimum query plan with respect to, for example, the execution time of the overall query. To optimize a query, the query plan optimizer 110 may obtain one or more costs for the different ways the execution of the query plan may be performed, and the costs may be in terms of execution time at, for example, the one or more databases 190.

A query plan compiler 112 may enable compilation of at least a portion of the query plan. The query plan compiler 112 may compile the optimized query algebra into operations, such as program code and/or any other type of command, operation, object, or instruction. This code may include pre-compiled code 114 (which may be pre-compiled and stored and then selected for certain operations in the query plan) and/or generated code 116 generated specifically for execution of the query plan. For example, the query plan compiler 112 may select pre-compiled code 114 for a given operation as part of the optimization of the query plan, while for another operation in the query plan the query plan compiler 112 may allow a compiler to generate the code (i.e., generated code 116). The pre-compiled code 114 and the generated code 116 represent code for executing the query plan, and this code may be provided to a query plan generator 118, which interfaces with the query execution engine 120.

In some example embodiments, the query optimizer 110 may optimize the query plan by compiling and generating code. Moreover, the query optimizer 110 may optimize the query plan to enable pipelining during execution. The query execution engine 120 may receive, from the query plan generator 118, compiled code to enable execution of the optimized query plan, although the query execution engine 120 may also receive code or other commands directly from a higher-level application or another source such as the one or more client devices 102. The pre-compiled code 114 and/or the generated code 116 may be provided to a plan execution engine 122 of the query execution engine 120. The plan execution engine 122 may then prepare the plan for execution, and this query plan may include the pre-compiled code 114 and/or the generated code 116. When the code for the query plan is ready for execution during runtime, the query execution engine 120 may step through the code, performing some of the operations within the database execution engine 150 and sending some of the operations (or commands in support of an operation, such as a read, write, and/or the like) for execution at one or more of one or more database 190.

In some example embodiments, the query execution engine 120 may run, as noted above, the generated code 116 generated for some query operations, while the pre-compiled code 114 may be run for other operations. Moreover, the query execution engine 120 may combine the generated code 116 with the pre-compiled code 114 to further optimize execution of query related operations. In addition, the query execution engine 120 may provide for a plan execution framework that is able to handle data chunk(s), pipelining, and state management during query execution. Furthermore, the query execution engine 120 may provide the ability to access table storage via an abstract interface to a table adapter, which may reduce dependencies on specific types of storage/persistence layers (which may enable use with different types of storage/persistence layers).

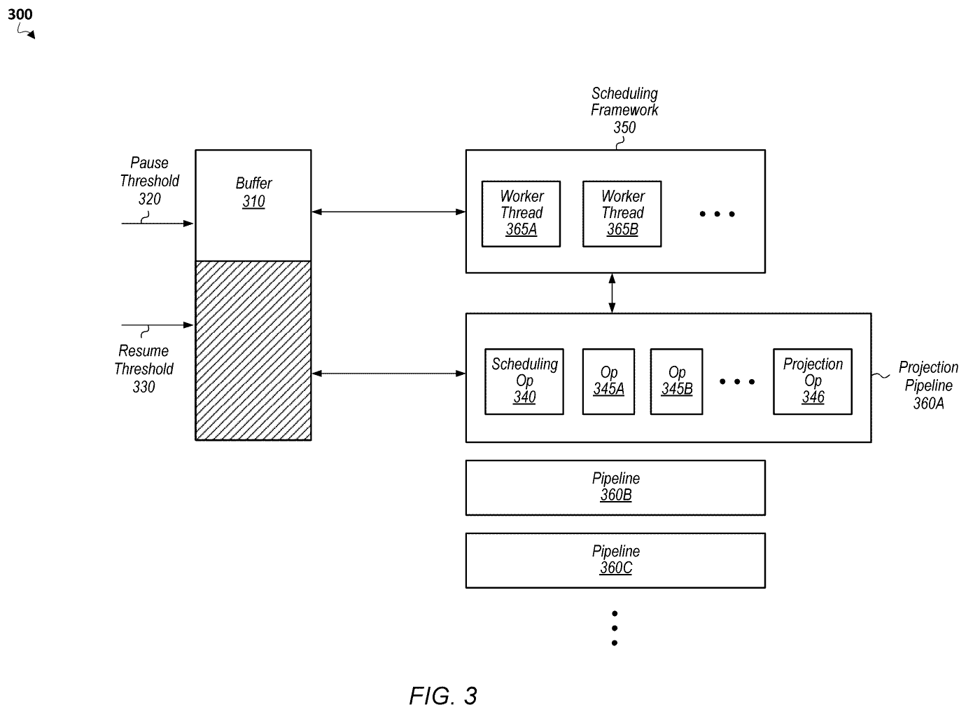

Referring now to FIG. 3, a block diagram of a result streaming environment 300 is depicted, in accordance with one or more embodiments of the current subject matter. In an example, result streaming environment 300 includes at least buffer 310, scheduling framework 350, and pipelines 360A-C. It is noted that result streaming environment 300 may also include other components which are not shown to avoid obscuring the figure.

When a query is received by a database execution engine (e.g., database execution engine 150 of FIG. 1), a query execution plan may be generated for the query. The query execution plan may include a plurality of query execution pipelines such as pipelines 360A-C. Each query execution pipeline in the plurality of query execution pipelines may be configured to execute a plurality of operations in a predetermined order associated with each query execution pipeline. In an example, pipeline 360A is a projection pipeline, and pipelines 360B-C are representative of any number of other types of query execution pipelines. As used herein, the term “projection pipeline” may be defined as a pipeline program that materializes result tuples into an output buffer from which client requests are satisfied. In other words, the “projection pipeline” projects output tuples to a temporary relation.

Scheduling framework 350 may create worker threads 365A-B which are representative of any number of worker threads. Worker threads 365A-B are executing the operators (e.g., op 345A, op 345B, projection op 346) contained in the projection pipeline 360A on parts of data that form tasks. It is noted that an operator may be referred to as an op for short. In an example, the work contained in the projection pipeline 360A is broken into tasks and the worker threads 365A-B repeatedly pick tasks and process them. Intermediate results generated by worker threads 365A-B may be stored in buffer 310, and buffer 310 may be associated with at least two thresholds, these thresholds being pause threshold 320 and resume threshold 330. It is noted that in FIG. 3, buffer 310 is shown as being partially filled, with the filled portion represented by the area shaded with diagonal lines within buffer 310.

When the results stored in buffer 310 reach pause threshold 320, the scheduling framework 350 may signal the worker threads 365A-B that they do not need to pick more tasks but instead should pause their activity. When the client fetches results, these results are removed from the buffer 310. When the results in the buffer 310 reach resume threshold 330, then work may be resumed and scheduling framework 350 may signal the worker threads 365A-B that they can resume their activity (i.e., pick new tasks to process). The unit of work for each worker thread 365A-B is a task. Each worker thread 365A-B keeps working on a task until the task is finished, and then when the task is finished, if the pause threshold 320 has not been reached, the respective worker thread 365A-B may pick up a new task to perform.

Scheduling operator 340 may be configured to determine various parameters associated with each received query. Scheduling operator 340 may also be configured to calculate an upper bound for a task size based on these parameters associated with a received query. The upper bound for the task size may then be utilized by scheduling framework 350 when scheduling worker threads 365A-B to perform tasks. In other words, the size of the task assigned to each worker thread 365A-B will be limited to the upper bound that is calculated by scheduling operator 340.

In an example, scheduling operator 340 determines an estimation of how large is the total work (number of rows) that the scheduling operator 340 will have to parallelize (e.g., the table size in cases when a table scan is parallelized). In this example, scheduling operator 340 also determines the estimated final result size (e.g., number of rows) at the projection. All of these estimates may be gathered and determined at plan generation time.

If the final_result is greater than a threshold (e.g., 0), then an upper bound is calculated for the task size at query runtime. In an example, the upper bound may be calculated based on the pause threshold 320. In an example, a goal may be that each thread will create a portion of the rows needed to hit the pause threshold 320. To control how large this portion should be, a configuration parameter named “targetOutputInProjectionReductionFactor” may be used. In an example, a goal may be that each thread will produce on the projection level: targetNumRowsOnProjectionLevel=max(minTargetOutputInProjection, pauseThreshold/ targetOutputInProjectionReductionFactor).

The configuration parameter named “minTargetOutputInProjection” is designed to prevent having a very small targetNumRowsOnProjectionLevel, especially in cases where the pause threshold 320 is relatively small. In order to find out how large the current task size on the level of the current scheduling operator 350 should be in order create targetNumRowsOnProjectionLevel results on the projection level, the following calculation may be made: taskSizeUpperBound=targetNumRowsOnProjectionLevel* estimatedTotalWork/estimatedFinalResultSize.

In an example, the upper bound is only applied if (1) the scheduling operator is on the projection pipeline and could take part in result streaming, and (2) if there is no distributed processing as sending data over the network first involves buffering some amount of data which might be larger than the taskSizeUpperBound. In case the scheduling operator 350 decides to parallelize, the upper bound is not used if the scheduling operator is below a limitOffsetOp and the limitoffset expects a large input, as parallelized implementations of a limit-offset operator typically involve the use of atomics and smaller task sizes could lead to contention on these atomics.

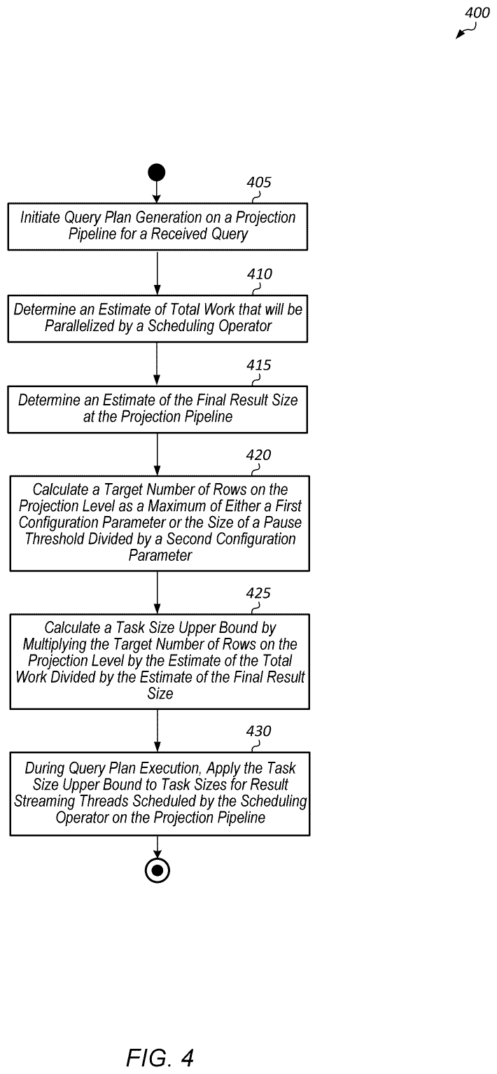

Referring now to FIG. 4, a process for enforcing an upper bound for task sizes in result streaming query processing is depicted, in accordance with one or more embodiments of the current subject matter. At the beginning of method 400, query plan generation on a projection pipeline is initiated for a received query (block 405). Next, an estimate of the total work that will be parallelized by a scheduling operator is determined (block 410). In an example, the estimate of the total work is calculated in terms of a number of rows to process. Also, an estimate of the final result size at the projection pipeline is determined (block 415). In an example, the estimate of the final result size is calculated as a number of rows.

Next, a target number of rows on the projection level is calculated as a maximum of either a first configuration parameter (e.g., minTargetOutputInProjection) or the size of a pause threshold divided by a second configuration parameter (e.g., targetOutputInProjectionReductionFactor) (block 420). Then, a task size upper bound is calculated by multiplying the target number of rows on the projection level by the estimate of the total work divided by the estimate of the final result size (block 425).

Next, during query plan execution, the task size upper bound is applied to task sizes for result streaming threads scheduled by the scheduling operator on the projection pipeline (block 430). In other words, in block 430, the number of rows in a task assigned to each thread is limited to the task size upper bound calculated in block 425. After block 430, method 400 may end.

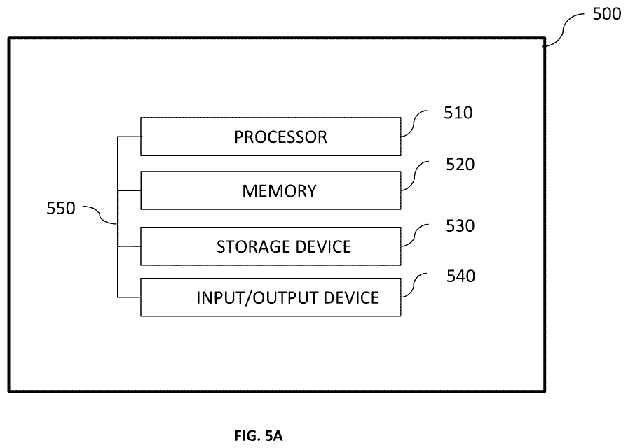

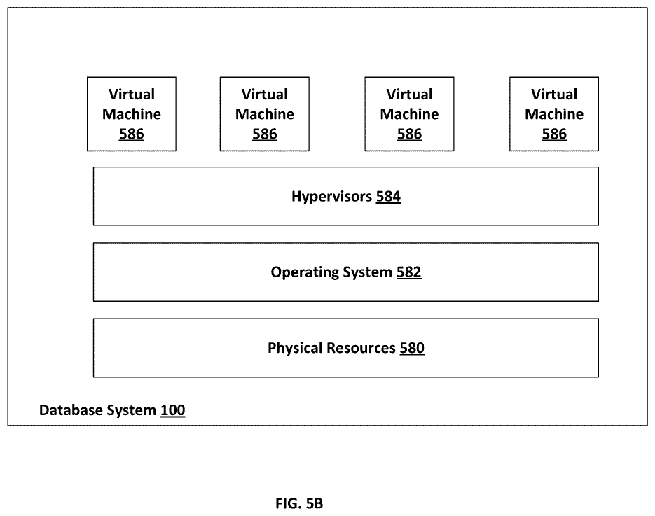

In some implementations, the current subject matter may be configured to be implemented in a system 500, as shown in FIG. 5A. The system 500 may include a processor 510, a memory 520, a storage device 530, and an input/output device 540. Each of the components 510, 520, 530 and 540 may be interconnected using a system bus 550. The processor 510 may be configured to process instructions for execution within the system 500. In some implementations, the processor 510 may be a single-threaded processor. In alternate implementations, the processor 510 may be a multi-threaded processor. The processor 510 may be further configured to process instructions stored in the memory 520 or on the storage device 530, including receiving or sending information through the input/output device 540. The memory 520 may store information within the system 500. In some implementations, the memory 520 may be a computer-readable medium. In alternate implementations, the memory 520 may be a volatile memory unit. In yet some implementations, the memory 520 may be a non-volatile memory unit. The storage device 530 may be capable of providing mass storage for the system 500. In some implementations, the storage device 530 may be a computer-readable medium. In alternate implementations, the storage device 530 may be a floppy disk device, a hard disk device, an optical disk device, a tape device, non-volatile solid state memory, or any other type of storage device. The input/output device 540 may be configured to provide input/output operations for the system 500. In some implementations, the input/output device 540 may include a keyboard and/or pointing device. In alternate implementations, the input/output device 540 may include a display unit for displaying graphical user interfaces.

FIG. 5B depicts an example implementation of the database system 100 (of FIG. 1). The database system 100 may be implemented using various physical resources 580, such as at least one or more hardware servers, at least one storage, at least one memory, at least one network interface, and the like. The database system 100 may also be implemented using infrastructure, as noted above, which may include at least one operating system 582 for the physical resources 580 and at least one hypervisor 584 (which may create and run at least one virtual machine 586). For example, each multitenant application may be run on a corresponding virtual machine 586.

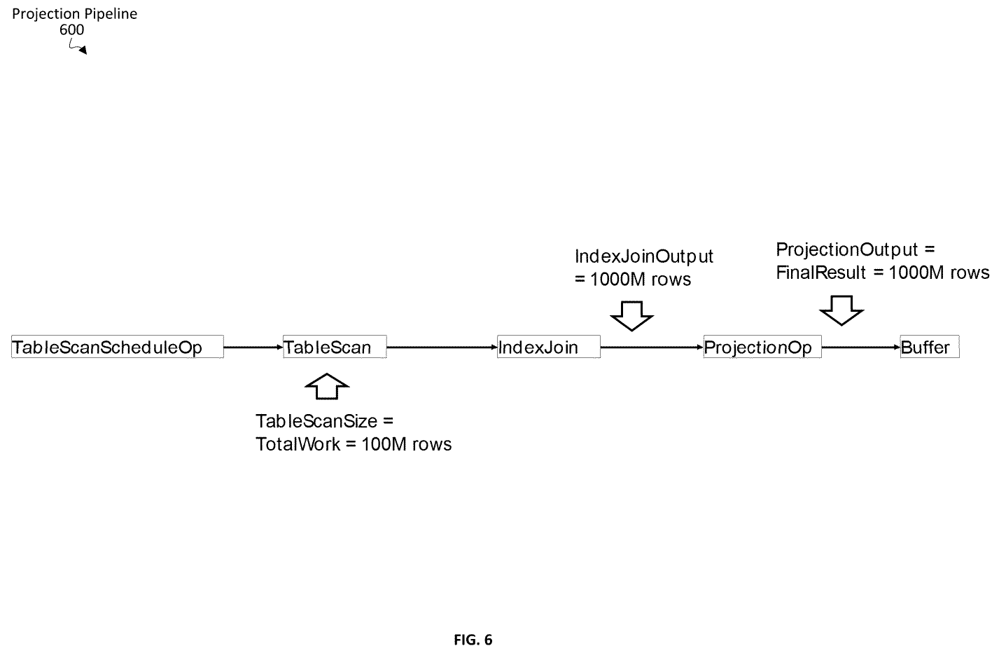

Turning now to FIG. 6, a diagram of an example projection pipeline 600 is shown, in accordance with some example implementations of the current subject matter. For the projection pipeline 600 shown in FIG. 6, the following assumptions may be made. First, the minTargetOutputInProjection=3000 rows. Second, the targetOutputInProjectionReductionFactor=10 and the Pause Threshold=500K rows. It is noted that the index join is an expanding join (i.e., outputs more rows than it receives in the input). Based on these assumptions, the targetNumRowsOnProjectionLevel=max(3000, 500K/10)=50K rows. The formula for calculating the task size upper bound, as previously presented, is the following: taskSizeUpperBound=targetNumRowsOnProjectionLevel * estimatedTotalWork/estimatedFinalResultSize. Based on the estimated total work=100M rows and estimated final result size=1000M, the calculation of the task size upper bound for projection pipeline 600 is the following: taskSizeUpperBound=50K*(100M/1000M)=5K rows. Accordingly, a task of 5K rows is needed for the table scan to get 50K rows in the buffer which is 1/10 (based on the targetOutputInProjectionReductionFactor) of the pause threshold.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C,” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: initiating generation of a query plan on a projection pipeline for a received query; determining a first estimate of total work that will be parallelized by a scheduling operator for the query plan; determining a second estimate of a final result size at the projection pipeline; calculating a target number of rows based on a pause threshold and one or more configuration parameters; calculating a task size upper bound by multiplying the target number of rows by the first estimate divided by the second estimate; and during execution of the query plan, applying the task size upper bound to task sizes for result streaming threads scheduled by the scheduling operator on the projection pipeline.

Example 2: The computer-implemented method of Example 1, wherein the target number of rows is calculated as a maximum of either a first configuration parameter or a size of the pause threshold divided by a second configuration parameter.

Example 3: The computer-implemented method of any of Examples 1-2, further comprising preventing a task size of any task assigned to a result streaming thread from exceeding the task size upper bound.

Example 4: The computer-implemented method of any of Examples 1-3, wherein the task size upper bound is only applied in response to the scheduling operator scheduling work on the projection pipeline.

Example 5: The computer-implemented method of any of Examples 1-4, wherein the task size upper bound is only applied in response to the scheduling operator implementing result streaming.

Example 6: The computer-implemented method of any of Examples 1-5, wherein the task size upper bound is only applied in response to distributed processing not being implemented.

Example 7: The computer-implemented method of any of Examples 1-6, wherein the first estimate of the total work is calculated in terms of a number of rows.

Example 8: The computer-implemented method of any of Examples 1-7, wherein the second estimate of the final result size at the projection pipeline is calculated in terms of a number of rows.

Example 9: The computer-implemented method of any of Examples 1-8, wherein the pause threshold specifies a particular fill level of a buffer, and wherein the computer-implemented method further comprising causing result streaming to pause responsive to detecting that an amount of intermediate results stored in the buffer has reached the particular fill level.

Example 10: A system comprising: at least one processor; and at least one memory storing instructions that, when executed by the at least one processor, cause operations comprising: initiating generation of a query plan on a projection pipeline for a received query; determining a first estimate of total work that will be parallelized by a scheduling operator for the query plan; determining a second estimate of a final result size at the projection pipeline; calculating a target number of rows based on a pause threshold and one or more configuration parameters; calculating a task size upper bound by multiplying the target number of rows by the first estimate divided by the second estimate; and during execution of the query plan, applying the task size upper bound to task sizes for result streaming threads scheduled by the scheduling operator on the projection pipeline.

Example 11: The system of Example 10, wherein the target number of rows is calculated as a maximum of either a first configuration parameter or a size of the pause threshold divided by a second configuration parameter.

Example 12: The system of any of Examples 10-11, wherein the operations further comprise preventing a task size of any task assigned to a result streaming thread from exceeding the task size upper bound.

Example 13: The system of any of Examples 10-12, wherein the task size upper bound is only applied in response to the scheduling operator scheduling work on the projection pipeline.

Example 14: The system of any of Examples 10-13, wherein the task size upper bound is only applied in response to the scheduling operator implementing result streaming.

Example 15: The system of any of Examples 10-14, wherein the task size upper bound is only applied in response to distributed processing not being implemented.

Example 16: The system of any of Examples 10-15, wherein the first estimate of the total work is calculated in terms of a number of rows.

Example 17: The system of any of Examples 10-16, wherein the second estimate of the final result size at the projection pipeline is calculated in terms of a number of rows.

Example 18: The system of any of Examples 10-17, wherein the pause threshold specifies a particular fill level of a buffer, and wherein the operations further comprise causing result streaming to pause responsive to detecting that an amount of intermediate results stored in the buffer has reached the particular fill level.

Example 19: A non-transitory computer readable medium storing instructions, which when executed by at least one data processor, result in operations comprising: initiating generation of a query plan on a projection pipeline for a received query; determining a first estimate of total work that will be parallelized by a scheduling operator for the query plan; determining a second estimate of a final result size at the projection pipeline; calculating a target number of rows based on a pause threshold and one or more configuration parameters; calculating a task size upper bound by multiplying the target number of rows by the first estimate divided by the second estimate; and during execution of the query plan, applying the task size upper bound to task sizes for result streaming threads scheduled by the scheduling operator on the projection pipeline.

Example 20: The non-transitory computer readable medium of Example 19, wherein the target number of rows is calculated as a maximum of either a first configuration parameter or a size of the pause threshold divided by a second configuration parameter.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method comprising:
initiating generation of a query plan on a projection pipeline for a received query, wherein the projection pipeline is configured to output execution results to a buffer from which client requests are satisfied;
determining a first estimate of total work that will be parallelized by a scheduling operator for the query plan;
determining a second estimate of a final result size at the projection pipeline;
calculating a target number of rows based on a pause threshold that specifies a first particular fill level of the buffer and one or more configuration parameters;
calculating a task size upper bound by multiplying the target number of rows by the first estimate divided by the second estimate; and
during execution of the query plan, executing a plurality of operators contained in the projection pipeline using one or more worker threads, in which the one or more worker threads perform result streaming by outputting the execution results to the buffer for storage until the pause threshold is satisfied, wherein the task size upper bound is applied to task sizes for the one or more worker threads scheduled by the scheduling operator on the projection pipeline.

2. The computer-implemented method of claim 1, wherein the target number of rows is calculated as a maximum of either a first configuration parameter or a size of the pause threshold divided by a second configuration parameter.

3. The computer-implemented method of claim 1, further comprising preventing a task size of any task assigned to a result streaming thread from exceeding the task size upper bound.

4. The computer-implemented method of claim 1, wherein the task size upper bound is only applied in response to the scheduling operator scheduling work on the projection pipeline.

5. The computer-implemented method of claim 1, wherein the task size upper bound is only applied in response to the scheduling operator implementing result streaming.

6. The computer-implemented method of claim 1, wherein the task size upper bound is only applied in response to distributed processing not being implemented.

7. The computer-implemented method of claim 1, wherein the first estimate of the total work is calculated in terms of a number of rows.

8. The computer-implemented method of claim 1, wherein the second estimate of the final result size at the projection pipeline is calculated in terms of a number of rows.

9. The computer-implemented method of claim 1, further comprising causing the result streaming by the one or more worker threads to pause responsive to detecting that an amount of intermediate results stored in the buffer has reached the first particular fill level specified by the pause threshold; and causing the result streaming by the one or more worker threads to resume responsive to detecting that the amount of intermediate results stored in the buffer has reached a second particular fill level specified by a resume threshold after reaching the first particular fill level, wherein the second particular fill level is lower than the first particular fill level.

10. A system comprising:
at least one processor; and
at least one memory storing instructions that, when executed by the at least one processor, cause operations comprising:
initiating generation of a query plan on a projection pipeline for a received query, wherein the projection pipeline is configured to output execution results to a buffer from which client requests are satisfied;
determining a first estimate of total work that will be parallelized by a scheduling operator for the query plan;
determining a second estimate of a final result size at the projection pipeline;
calculating a target number of rows based on a pause threshold that specifies a first particular fill level of the buffer and one or more configuration parameters;
calculating a task size upper bound by multiplying the target number of rows by the first estimate divided by the second estimate; and
during execution of the query plan, executing a plurality of operators contained in the protection pipeline using one or more worker threads, in which the one or more worker threads perform result streaming by outputting the execution results to the buffer for storage until the pause threshold is satisfied, wherein the task size upper bound is applied to task sizes for the one or more worker threads scheduled by the scheduling operator on the projection pipeline.

11. The system of claim 10, wherein the target number of rows is calculated as a maximum of either a first configuration parameter or a size of the pause threshold divided by a second configuration parameter.

12. The system of claim 10, wherein the operations further comprise preventing a task size of any task assigned to a result streaming thread from exceeding the task size upper bound.

13. The system of claim 10, wherein the task size upper bound is only applied in response to the scheduling operator scheduling work on the projection pipeline.

14. The system of claim 10, wherein the task size upper bound is only applied in response to the scheduling operator implementing result streaming.

15. The system of claim 10, wherein the task size upper bound is only applied in response to distributed processing not being implemented.

16. The system of claim 10, wherein the first estimate of the total work is calculated in terms of a number of rows.

17. The system of claim 10, wherein the second estimate of the final result size at the projection pipeline is calculated in terms of a number of rows.

18. The system of claim 10, wherein the operations further comprise causing the result streaming by the one or more worker threads to pause responsive to detecting that an amount of intermediate results stored in the buffer has reached the first particular fill level specified by the pause threshold; and causing the result streaming by the one or more worker threads to resume responsive to detecting that the amount of intermediate results stored in the buffer has reached a second particular fill level specified by a resume threshold after reaching the first particular fill level, wherein the second particular fill level is lower than the first particular fill level.

19. A non-transitory computer readable medium storing instructions, which when executed by at least one data processor, result in operations comprising:
initiating generation of a query plan on a projection pipeline for a received query, wherein the projection pipeline is configured to output execution results to a buffer from which client requests are satisfied;
determining a first estimate of total work that will be parallelized by a scheduling operator for the query plan;
determining a second estimate of a final result size at the projection pipeline;
calculating a target number of rows based on a pause threshold that specifies a first particular fill level of the buffer and one or more configuration parameters;
calculating a task size upper bound by multiplying the target number of rows by the first estimate divided by the second estimate; and
during execution of the query plan, executing a plurality of operators contained in the projection pipeline using one or more worker threads, in which the one or more worker threads perform result streaming by outputting the execution results to the buffer for storage until the pause threshold is satisfied, wherein the task size upper bound is applied to task sizes for the one or more worker threads scheduled by the scheduling operator on the projection pipeline.

20. The non-transitory computer readable medium of claim 19, wherein the target number of rows is calculated as a maximum of either a first configuration parameter or a size of the pause threshold divided by a second configuration parameter.
